(19) United States
(12) Patent Application Publication
(10) Pub. No.: US 2012/0131436 A1
(43) Pub. Date: May 24, 2012

(54) AUTOMATED REPORT GENERATION WITH LINKS

(75) Inventors: Andrei Leontiev, St. George, VT (US); Alexander Natanzon, Upper Saddle River, NJ (US)

(73) Assignee: General Electric Company, Schenectady, NY (US)

(21) Appl. No.: 12/954,255

(22) Filed: Nov. 24, 2010

(51) Int. Cl. G06F 17/00

(52) U.S. Cl. 715/233

(57) ABSTRACT

An example method for image review and reporting includes providing access to a report including one or more entries associated with image content. The method includes facilitating user selection of an entry in the report. The method includes displaying one or more images and image annotations associated with the entry in a viewer for the user. The method includes configuring the viewer according to a presentation state and workflow associated with the entry. The method includes enabling user continuation of the workflow with respect to the presentation state and the one or more images and image annotations associated with the entry.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

PACS were initially used as an information infrastructure supporting storage, distribution, and diagnostic reading of images acquired in the course of medical examinations. As PACS developed and became capable of accommodating vast volumes of information and its secure access, PACS began to expand into the information-oriented business and professional areas of diagnostic and general healthcare enterprises. For various reasons, including but not limited to a natural tendency of having one information technology (IT) department, one server room, and one data archive/backup for all departments in healthcare enterprise, as well as one desktop workstation used for all business day activities of any healthcare professional, PACS is considered as a platform for growing into a general IT solution for the majority of IT oriented services of healthcare enterprises.

Medical imaging devices now produce diagnostic images in a digital representation. The digital representation typically includes a two dimensional raster of the image equipped with a header including collateral information with respect to the image itself, patient demographics, imaging technology, and other data used for proper presentation and diagnostic interpretation of the image. Often, diagnostic images are grouped in series each series representing images that have some commonality and differ in one or more details. For example, images representing anatomical cross-sections of a human body substantially normal to its vertical axis and differing by their position on that axis from top (head) to bottom (feet) are grouped in so-called axial series. A single medical exam, often referred as a “study” or an “exam” typically includes one or more series of images, such as images exposed before and after injection of contrast material or images with different orientation or differing by any other relevant circumstance(s) of imaging procedure. The digital images are forwarded to specialized archives equipped with proper means for safe storage, search, access, and distribution of the images and collateral information for successful diagnostic interpretation.

### BRIEF SUMMARY

Certain examples provide systems, methods, and apparatus for image review, analysis, reporting, and sharing.

Certain examples provide a computer-implemented method for image review and reporting. The method includes providing access to a report including one or more entries associated with image content. The method includes facilitating user selection of an entry in the report. The method includes displaying one or more images and image annotations associated with the entry in a viewer for the user. The method includes configuring the viewer according to a presentation state and workflow associated with the entry. The method includes enabling user continuation of the workflow with respect to the presentation state and the one or more images and image annotations associated with the entry.

Certain examples provide an image analysis and reporting system. The system includes a user interface to facilitate user review and interaction with image content and an associated report. The system includes an image editor to provide access to image content for review and annotation via the user interface. The system includes a report manager to provide access to a report including one or more entries associated with image content via the user interface. The report manager is to work with the user interface to facilitate user selection of an entry in the report. The image editor is to work with the user interface to display one or more images and image annotations associated with the entry and to configure the user interface according to a presentation state and workflow associated with the entry. The image editor is to enable user continuation of the workflow with respect to the presentation state and the one or more images and image annotations associated with the entry.

Certain examples provide a tangible computer readable medium having a set of instructions for execution on a processing device, the set of instructions implementing a method for image review and reporting. The method includes providing access to a report including one or more entries associated with image content. The method includes facilitating user selection of an entry in the report. The method includes displaying one or more images and image annotations associated with the entry in a viewer for the user. The method includes configuring the viewer according to a presentation state and workflow associated with the entry. The method includes enabling user continuation of the workflow with respect to the presentation state and the one or more images and image annotations associated with the entry.

### BRIEF DESCRIPTION OF SEVERAL VIEWS OF THE DRAWINGS

FIG. 1 illustrates an example report table including a plurality of measurement and/or other annotation entries identified in one or more reviewed images.

FIG. 2 illustrates an example image review interface providing images and associated measurements and/or other annotations for user review.

FIG. 3 illustrates an example report table including a plurality of measurement and/or other annotation entries identified in one or more reviewed images.

FIG. 4 illustrates an example image review interface providing images and associated measurements and/or other annotations for user review.

FIG. 5 illustrates a block diagram of an example clinical information system.

FIG. 6 illustrates an example reporting and analysis system to facilitate a user workflow for image review, analysis, and reporting.

FIG. 7 illustrates a flow diagram for an example method for user report generation and workflow facilitation.

FIG. 8 shows a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples provide an augmented reporting template that detects references to acquired images and allows a reviewing physician to make measurements and/or annotations to the image(s) within the template. The measurement/annotation value is automatically transferred to a report along with an active link into the image with the measurement/annotation itself so that someone reading the report can simply click on the link to retrieve the actual image and information. In certain examples, report-ready excerpts of the image with the measurement/annotation value can be made available for user selection for inclusion into a report, for example.

Prior approaches provide a simplistic way of showing report and key images. A radiologist can show a collage of images next to the report, but there is no direct linkage to the images themselves. For example, a user can be reading a report that discusses a mass in an image. The user then must hunt through key images and to find that particular mass in those key images. In certain examples, a report template is augmented so that when the radiologist is making a particular measurement and working with a report template, the system knows that this particular measurement goes into that portion of the report. Multiple actions or events are occurring together: 1) a measurement is made on the image, 2) the value of that measurement goes into report, and 3) an active link is created in the report so that when a physician reads the report, the link can be selected by the physician to go exactly to that image and the measurement cited in the report.

In certain examples, auto-segmentation, automatic creation of a report (e.g., using template reports, etc.), and pigmentation of regions can be facilitated by a user interface and supporting application(s).

In certain examples, a user can configure his or her system so that any measurement can be recorded as part of a report. A link between a measurement and a report template can be manually and/or automatically created, and details are automatically added as the report and associated image(s) are processed. When a physician or other user looks at the report, those measurements are represented as active links. If key image(s) are provided with the measurements, the key image(s) are also shown. Thus, text, numerical output, and images are interconnected, interrelated, and provided together in a report for access, review, and manipulation.

In certain examples, link(s) can be provided between a wide variety of diagnostic statements, whether the statement is a measurement, a lesion, etc., and the visual content of the exam. In certain examples, link(s) are provided both on-line and off-line. When a user is reading a report on-line and reaches a statement in the report, the user can select (e.g., click on) the statement and will automatically be shown the image(s) that illustrate the statement, for example.

Images can be identified automatically and/or manually. Images can be identified in a variety of ways. For example, if image are added to a collage, print page, etc., images can be identified online and/or downloaded to a reviewer's system. If a user is offline, illustrative image linked to diagnostic statements can be scanned for inclusion, for example.

In certain examples, a report is rendered to be directly linked to a distribution channel based on receiving party preferences (e.g., system-to-system, application-to-application, system-to-person, etc.), media, contents (e.g., positive v. negative, urgency), etc.

Certain examples provide easily accessible report and associated image and measurement/annotation content to a physician and/or other healthcare practitioner, rather than requiring users to manually locate and access the images and associated measurements/annotations separate from the report.

Certain examples provide bi-directional linkage between measurements and/or other annotations in an image and an associated report and/or other documentation. Certain examples record and store a workflow (e.g., prior workflow steps and/or information for further workflow steps) in association with the image and/or report information.

Certain examples save workflow and state information with respect to image findings in a report and allow access and resumption of workflow via a variety of applications (e.g., a dictation application, a radiology viewer, etc.) in a clinical workspace environment.

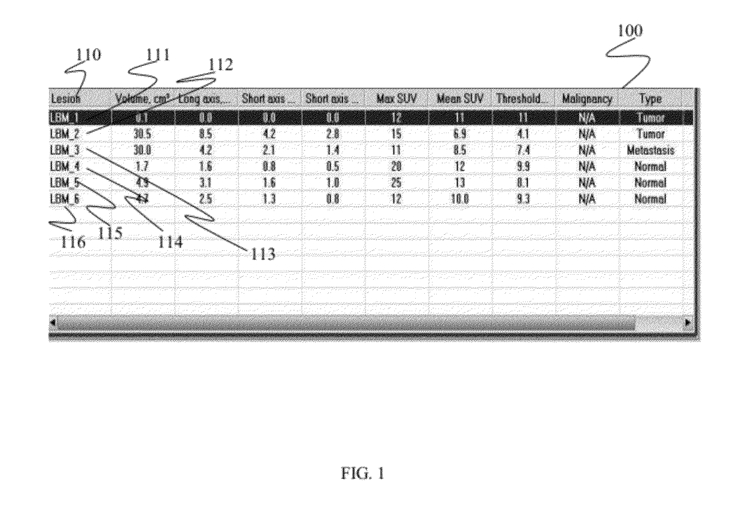

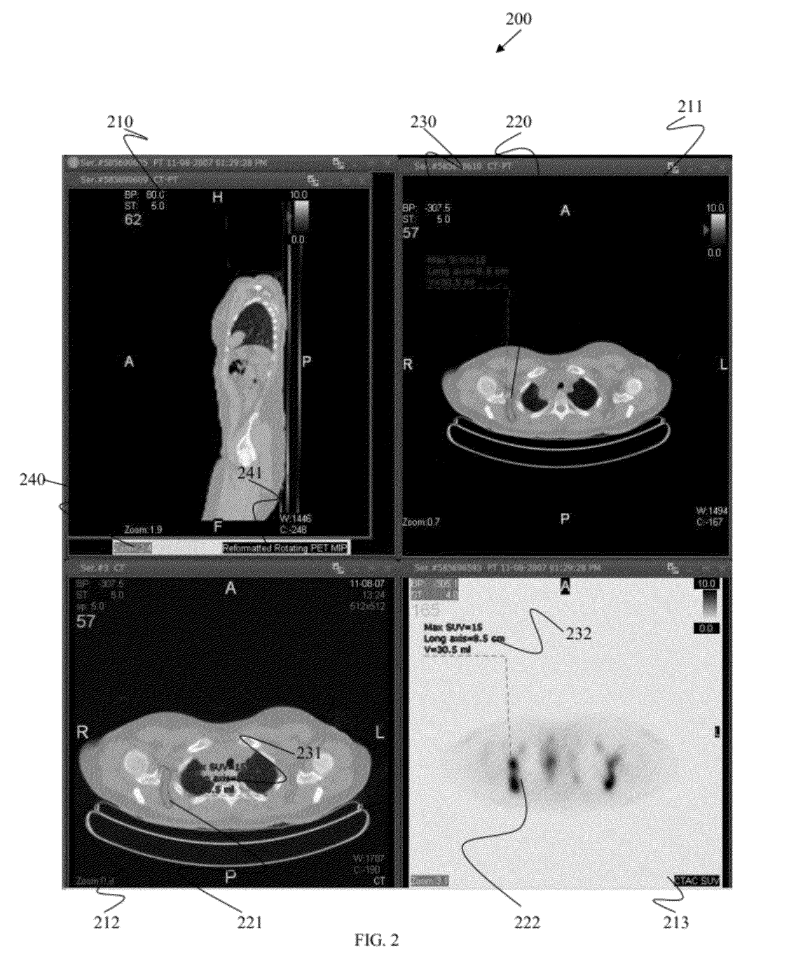

FIG. 1 illustrates an example report table 100 including a plurality of lesions 110 identified in one or more reviewed images. Each lesion entry 111-116 in the table 100 can be selected by a user to access corresponding image(s) (and/or other associated content), for example. For example, a user can select a first lesion entry 111 in the report table 100. Upon selection of the entry 111, the user is taken to an image review interface, such as the interface 200 shown in FIG. 2.

Table(s) 100 in the report are being populated as a user makes certain measurements on particular image(s) and are linked so that as a user highlights a number and/or other field on the report 100, the user can see exactly from where the information was obtained. Each line 111-116 in the table 100 represents a finding or follow-up statement. For example, if the report is from an initial visit, the user sees observed lesion(s) of a certain type, found in a certain organ, having a certain diameter, in a certain diagnostic state, etc. If the report is generated at follow-up visit, the user can see the measurements over time, for example.

Each time a user selects an entry 111-116 in the report table 100, a presentation state of the user's viewer is changed so that all images are centered on the selected entry (e.g., the selected lesion). Using the viewer and its updated presentation state, the user can re-measure what is there and/or can use the images for different operations other than review, for example.

For example, a radiation oncologist can see a list of lesions and select which one(s) that will be the focus of his or her review. After being taken into the correct presentation context with the image(s) of the selected lesion(s), his or she can draw his or her own contours on the image(s) to determine where high radiation dose should be applied to treat the lesion(s). The user can mark a critical organ next to lesion and build a radiation plan to avoid high radiation in this area, for example.

In certain examples, not only is a linkage provided between report content and associated image(s), but a linkage is provided between two comprehensive instruments: 1) a concentrated report and 2) an application. The link is not just to an image, but is a link to a starting point in a workflow, for example.

FIG. 2 illustrates an example image review interface 200 providing images 210-213 and associated measurements and/or other annotations for user review. The images 210-213 include one or more measurements, regions of interest, and/or other annotations 220-222. The one or more measurements, regions of interest, and/or other annotations 220-222 can be associated with one or more labels and/or other notes and/or indicators 230-232, for example. In the example of FIG. 2, the images 210-213 highlight the selected lesion 111, 220-222 from the report table 100 of FIG. 1. By selecting the lesion entry 111, the image content 200 is provided in a workflow state and/or presentation context associated with the identification, labeling, and measurement of the lesion 111 in the images 210-213 of FIG. 2.

Once the user is viewing the images 210-213, the user can continue from that point in the workflow to go back and change a previous action performed with respect to one or more of the images 210-213 and/or associated annotations 220-222 and/or labels 230-232. Additionally, the user can continue from the saved workflow point to identify further regions of interest, perform further measurements, etc. These actions can be saved with respect to the table 100 and/or other report, for example.

For example, in the viewer 200 of FIG. 2, a zoom factor 240 and reformatting operation notation 241 have been applied to the image 210. Entering the workflow from the linked and stored presentation state, a user can change the zoom factor 240 and/or undue and/or alter the reformatting (e.g., to apply another image operation) 241, for example. Changes can be saved with respect to the original report data set and/or can be used to create a separate report, for example.

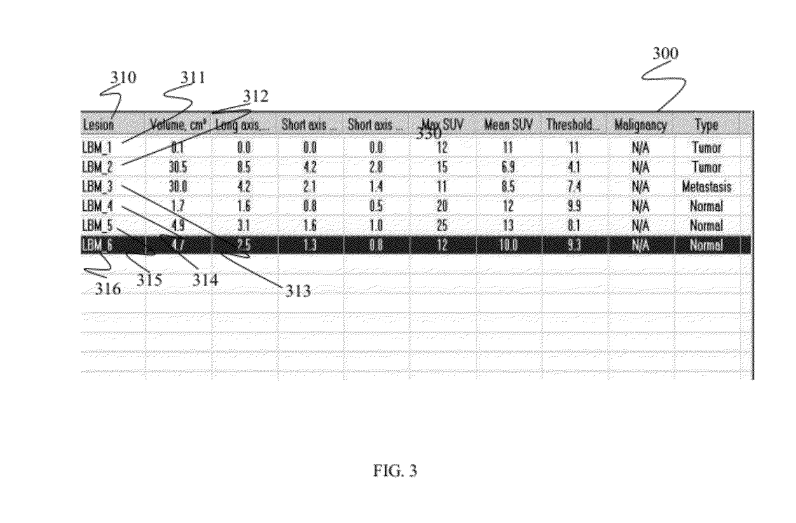

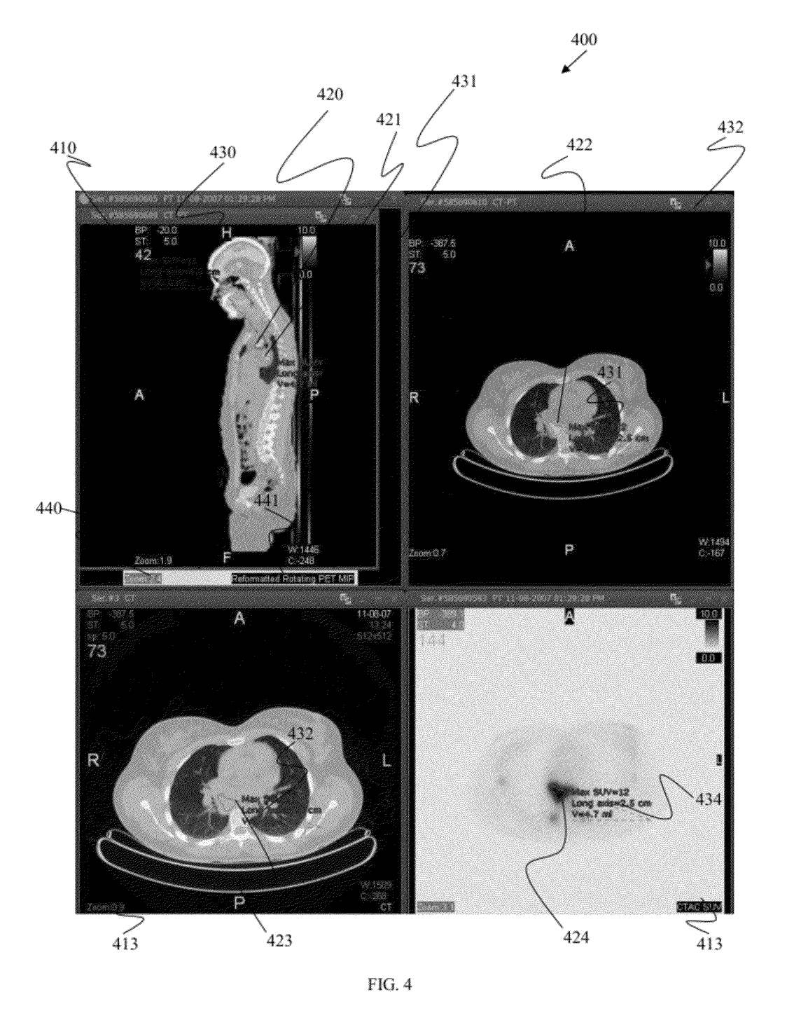

FIG. 3 illustrates an example report table 300 including a plurality of lesions 110 identified in one or more reviewed images. The report table 300 is similar to report table 100 depicted in FIG. 1. Each lesion entry 311-316 in the table 300 can be selected by a user to access corresponding image(s) (and/or other associated content), for example. For example, a user can select a last lesion entry 316 in the report table 300. Upon selection of the entry 316, the user is taken to an image review interface, such as the interface 400 shown in FIG. 4.

While the example report table 100 shows selection of a first entry 111 which results in a first presentation content and workflow state depicted in the example viewer 200 of FIG. 2, the example report table 200 shows selection of a last entry 316 which results in a different presentation content and workflow state depicted in an example viewer 400 of FIG. 4. While the content and workflow state of the viewer 200 centered around the selected lesion entry 111, the content and workflow state of the viewer 400 center around the selected lesion entry 316.

FIG. 4 illustrates an example image review interface 400 providing images 410-413 and associated measurements and/or other annotations for user review. The images 410-413 include one or more measurements, regions of interest, and/or other annotations 420-424. The one or more measurements, regions of interest, and/or other annotations 420-424 can be associated with one or more labels and/or other notes and/or indicators 430-434, for example. In the example of FIG. 4, the images 410-413 highlight the selected lesion 316, 420-424 from the report table 300 of FIG. 3. By selecting the lesion entry 316, the image content 400 is provided in a workflow state and/or presentation context associated with the identification, labeling, and measurement of the lesion 316 (as opposed to the workflow state and/or presentation context of lesion 311) in the images 410-413 of FIG. 4.

Once the user is viewing the images 410-413, the user can continue from that point in the workflow to go back and change a previous action performed with respect to one or more of the images 410-413 and/or associated annotations 420-424 and/or labels 430-434. Additionally, the user can continue from the saved workflow point to identify further regions of interest, perform further measurements, etc. These actions can be saved with respect to the table 300 and/or other report, for example.

For example, in the viewer 400 of FIG. 4, a zoom factor 440 and reformatting operation notation 441 have been applied to the image 410. Entering the workflow from the linked and stored presentation state, a user can change the zoom factor 440 and/or undue and/or alter the reformatting (e.g., to apply another image operation) 441, for example. Changes can be saved with respect to the original report data set and/or can be used to create a separate report, for example.

Thus, by selecting different entries 110-116, 310-136 in a report 100, 300, the user's interface and/or application is configured according to different information, in a different presentation state, for a different workflow, which the user can then revised and/or continue, for example.

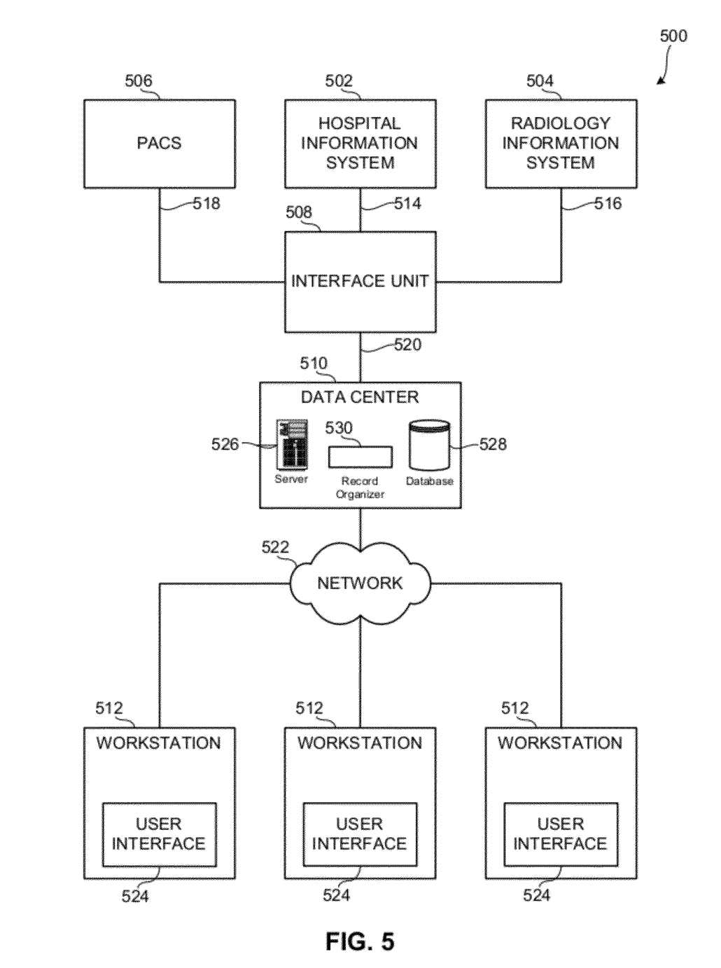

FIG. 5 shows a block diagram of an example clinical information system 500 capable of implementing the example methods and systems described herein. The example clinical information system 500 includes a hospital information system (HIS) 502, a radiology information system (RIS) 504, a picture archiving and communication system (PACS) 506, an interface unit 508, a data center 510, and a plurality of workstations 512. In the illustrated example, the HIS 502, the RIS 504, and the PACS 506 are housed in a healthcare facility and locally archived. However, in other implementations, the HIS 502, the RIS 504, and/or the PACS 506 can be housed one or more other suitable locations. In certain implementations, one or more of the PACS 506, RIS 504, HIS 502, etc., can be implemented remotely via a thin client and/or downloadable software solution. Furthermore, one or more components of the clinical information system 500 can be combined and/or implemented together. For example, the RIS 504 and/or the PACS 506 can be integrated with the HIS 502; the PACS 506 can be integrated with the RIS 504; and/or the three example information systems 502, 504, and/or 506 can be integrated together. In other example implementations, the clinical information system 500 includes a subset of the illustrated information systems 502, 504, and/or 506. For example, the clinical information system 500 can include only one or two of the HIS 502, the RIS 504, and/or the PACS 506. Information (e.g., scheduling, test results, observations, diagnosis, etc.) can be entered into the HIS 502, the RIS 504, and/or the PACS 506 by healthcare practitioners (e.g., radiologists, physicians, and/or technicians) before and/or after patient examination.

The HIS 502 stores medical information such as clinical reports, patient information, and/or administrative information received from, for example, personnel at a hospital, clinic, and/or a physician's office. The RIS 504 stores information such as, for example, radiology reports, messages, warnings, alerts, patient scheduling information, patient demographic data, patient tracking information, and/or physician and patient status monitors. Additionally, the RIS 504 enables exam order entry (e.g., ordering an x-ray of a patient) and image and film tracking (e.g., tracking identities of one or more people that have checked out a film). In some examples, information in the RIS 504 is formatted according to the HL-7 (Health Level Seven) clinical communication protocol.

The PACS 506 stores medical images (e.g., x-rays, scans, three-dimensional renderings, etc.) as, for example, digital images in a database or registry. In some examples, the medical images are stored in the PACS 506 using the Digital Imaging and Communications in Medicine (“DICOM”) format. Images are stored in the PACS 306 by healthcare practitioners (e.g., imaging technicians, physicians, radiologists) after a medical imaging of a patient and/or are automatically transmitted from medical imaging devices to the PACS 506 for storage. In some examples, the PACS 506 can also include a display device and/or viewing workstation to enable a healthcare practitioner to communicate with the PACS 506.

The interface unit 508 includes a hospital information system interface connection 514, a radiology information system interface connection 516, a PACS interface connection 518, and a data center interface connection 520. The interface unit 508 facilities communication among the HIS 502, the RIS 504, the PACS 506, and/or the data center 510. The interface connections 514, 516, 518, and 520 can be implemented by, for example, a Wide Area Network (“WAN”) such as a private network or the Internet. Accordingly, the interface unit 508 includes one or more communication components such as, for example, an Ethernet device, an asynchronous transfer mode (“ATM”) device, an 802.11 device, a DSL modem, a cable modem, a cellular modem, etc. In turn, the data center 510 communicates with the plurality of workstations 512, via a network 522, implemented at a plurality of locations (e.g., a hospital, clinic, doctor's office, other medical office, or terminal, etc.). The network 522 is implemented by, for example, the Internet, an intranet, a private network, a wired or wireless Local Area Network, and/or a wired or wireless Wide Area Network. In some examples, the interface unit 508 also includes a broker (e.g., a Mitra Imaging's PACS Broker) to allow medical information and medical images to be transmitted together and stored together.

In operation, the interface unit 508 receives images, medical reports, administrative information, and/or other clinical information from the information systems 502, 504, 506 via the interface connections 514, 516, 518. If necessary (e.g., when different formats of the received information are incompatible), the interface unit 508 translates or reformats (e.g., into Structured Query Language (“SQL”) or standard text) the medical information, such as medical reports, to be properly stored at the data center 510. The reformatted medical information can be transmitted using a transmission protocol to enable different medical information to share common identification elements, such as a patient name or social security number. Next, the interface unit 508 transmits the medical information to the data center 510 via the data center interface connection 520. Finally, medical information is stored in the data center 510 in, for example, the DICOM format, which enables medical images and corresponding medical information to be transmitted and stored together.

The medical information is later viewable and easily retrievable at one or more of the workstations 512 (e.g., by their common identification element, such as a patient name or record number). The workstations 512 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstations 512 receive commands and/or other input from a user via, for example, a keyboard, mouse, track ball, microphone, etc. As shown in FIG. 5, the workstations 512 are connected to the network 522 and, thus, can communicate with each other, the data center 510, and/or any other device coupled to the network 522. The workstations 512 are capable of implementing a user interface 524 to enable a healthcare practitioner to interact with the clinical information system 500. For example, in response to a request from a physician, the user interface 524 presents a patient medical history. Additionally, the user interface 524 includes one or more options related to the example methods and apparatus described herein to organize such a medical history using classification and severity parameters.

The example data center 510 of FIG. 5 is an archive to store information such as, for example, images, data, medical reports, and/or, more generally, patient medical records. In addition, the data center 510 can also serve as a central conduit to information located at other sources such as, for example, local archives, hospital information systems/radiology information systems (e.g., the HIS 502 and/or the RIS 504), or medical imaging/storage systems (e.g., the PACS 506 and/or connected imaging modalities). That is, the data center 510 can store links or indicators (e.g., identification numbers, patient names, or record numbers) to information. In the illustrated example, the data center 510 is managed by an application server provider (“ASP”) and is located in a centralized location that can be accessed by a plurality of systems and facilities (e.g., hospitals, clinics, doctor's offices, other medical offices, and/or terminals). In some examples, the data center 510 can be spatially distant from the HIS 502, the RIS 504, and/or the PACS 506 (e.g., at General Electric® headquarters).

The example data center 510 of FIG. 5 includes a server 526, a database 528, and a record organizer 530. The server 526 receives, processes, and conveys information to and from the components of the clinical information system 500. The database 528 stores the medical information described herein and provides access thereto. The example record organizer 530 of FIG. 5 manages patient medical histories, for example. The record organizer 530 can also assist in procedure scheduling, for example.

Images and related data are displayed at a client workstation for radiologist and/or other clinician review. When a user has many images for review and not enough real estate for display of the images on a monitor, the user must drag images from the navigator to an area on the monitor for large scale review. Such a manual approach involves much mouse movement and user fatigue.

In certain examples, a review workstation display can be configured and divided into a plurality of segments or quadrants to display multiple images and/or other data. Images and/or other data can be placed in the segments of the display automatically based on certain parameters and/or based on user preference, for example. Software running on the workstation can keep track of how many segments have been created on the display and what content is displayed in which segment (if any). Software running on the workstation can interact in thick and/or thin client operation to retrieve images and/or other data locally and/or remotely for display in one or more segments, for example. Images and/or other data can be from the same and/or multiple modalities, for example.

Hanging protocols can be used to define an arrangement of images and/or other information on a display. A workflow may involve an overview set of images and more focused sets of images. The workflow may require stepping through various configurations of images. A typical workflow can be an array or sequence of hangings, for example.

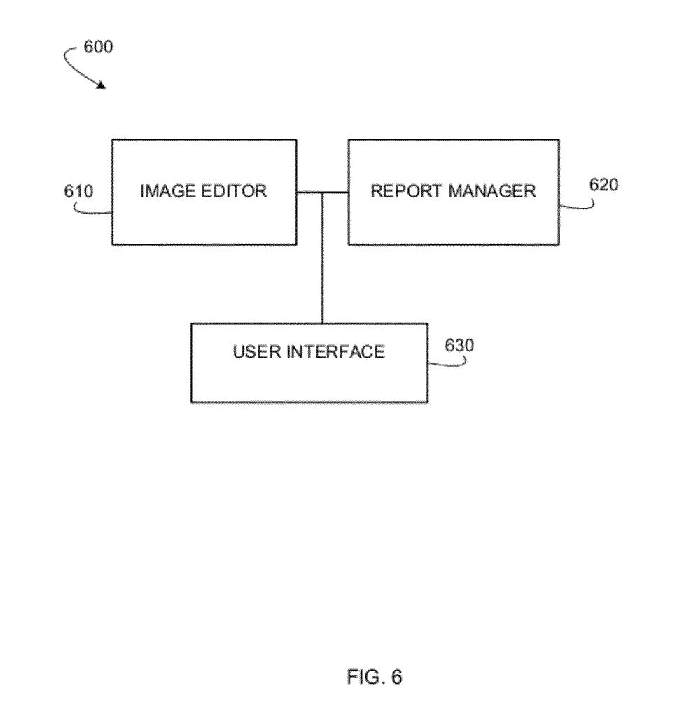

FIG. 6 illustrates an example reporting and analysis system 600 to facilitate a user workflow for image review, analysis, and reporting. The system 600 includes an image editor 610, a report manager 620, and a user interface 630. Via the user interface 630, a user can review and edit one or more images and/or associated content from the image editor 610. One or more measurements, labels, region highlights, findings, and/or other annotations can be made to an image. Such user interaction with respect to an image results in a report entry being generated by the report manager 620 in conjunction with the image editor 610, for example.

Once a report has been generated, a user can access the report via the user interface 630 and the report manager 620. Upon selecting a report entry corresponding to a reviewed image, for example, the user is taken to view image(s) related to the selected entry. The report manager 620 and image editor 610 place the user interface 630 in a presentation and workflow state based on the selected entry. The user can then review image(s), make, edit, and/or remove measurements, labels, findings, highlights, and/or other annotations, and continue to create and/or modify report entry(ies) and perform further actions within the linked, saved workflow and presentation state, for example.

The image editor 610, a report manager 620, and a user interface 630 can be implemented in software, hardware, firmware, and/or a combination of these elements. The image editor 610, a report manager 620, and a user interface 630 can be implemented separately and/or combined in various forms. The image editor 610, a report manager 620, and a user interface 630 can be implemented as a set of instructions/routines forming machine executable code stored on a machine accessible medium for execution by a computing/processing device, for example.

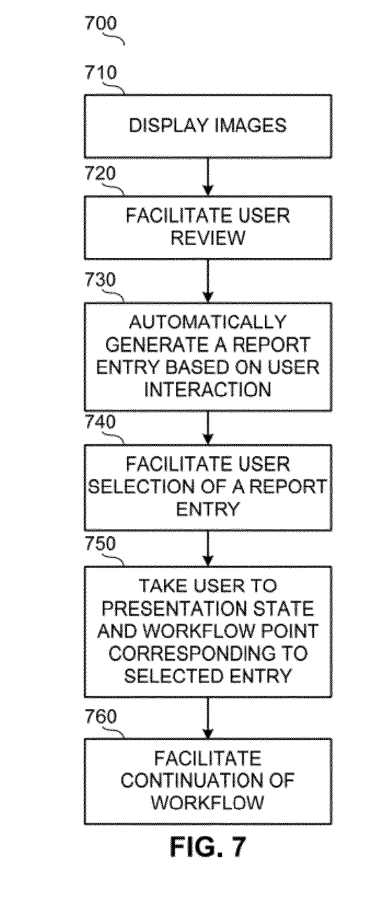

FIG. 7 depicts a flow diagram representative of example machine readable instructions that can be executed to implement the example systems shown in FIGS. 1-6 and/or portions of one or more of those systems. The example process(es) of FIG. 7 can be performed using a processor, a controller and/or any other suitable processing device. For example, the example process(es) of FIG. 7 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 7 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 7 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 7 can be implemented manually or as any combination(s) of any of the foregoing techniques, for example, any combination of firmware, software, discrete logic and/or hardware. Further, although the example process(es) of FIG. 7 are described with reference to the flow diagram of FIG. 7, other methods of implementing the process(es) of FIG. 7 can be employed. For example, the order of execution of the blocks can be changed, and/or some of the blocks described can be changed, eliminated, sub-divided, or combined. Additionally, any or all of the example process(es) of FIG. 7 can be performed sequentially and/or in parallel by, for example, separate processing threads, processors, devices, discrete logic, circuits, etc.

FIG. 7 illustrates a flow diagram for an example method 700 for user report generation and workflow facilitation. At block 710, one or more images and/or other information is loaded and displayed to a user. For example, a series of computed tomography images are displayed in a layout on a PACS workstation display.

At block 720, user review of the image(s) is facilitated using one or more tools for measurement, annotation, region highlighting, etc. At block 730, upon user interaction with an image (e.g., to measure, mark a region of interest or other finding, annotate, etc.), a report entry is automatically generated with respect to the image. For example, a report entry and/or excerpt suitable for placement (e.g., drag and drop, copy and paste, etc.) into a report is automatically generated in response to a user action with respect to a displayed image. The report entry includes associated information, presentation state, and workflow status, for example.

At block 740, user selection of an entry in a report is facilitated. For example, a user can select a lesion report entry a report. At 750, the user is taken to corresponding image(s) associated with the selected report entry. For example, a viewer is configured according to a saved presentation state, content information, and workflow status corresponding to the selected report entry.

At 760, the user's continuation of the image workflow is continued. For example, once the user is viewing the retrieved images, the user can continue from that point in the workflow to go back and change a previous action performed with respect to one or more of the images and/or associated measurements, labels, and/or other annotations. Additionally, the user can continue from the saved workflow point to identify further regions of interest, perform further measurements, etc. These actions can be saved with respect to the same report and/or another report, for example.

One or more of the blocks of the method 700 can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device.

Certain examples can omit one or more of these blocks and/or perform the blocks in a different order than the order listed. For example, some steps may not be performed in certain examples. As a further example, certain steps can be performed in a different temporal order, including simultaneously, than listed above.

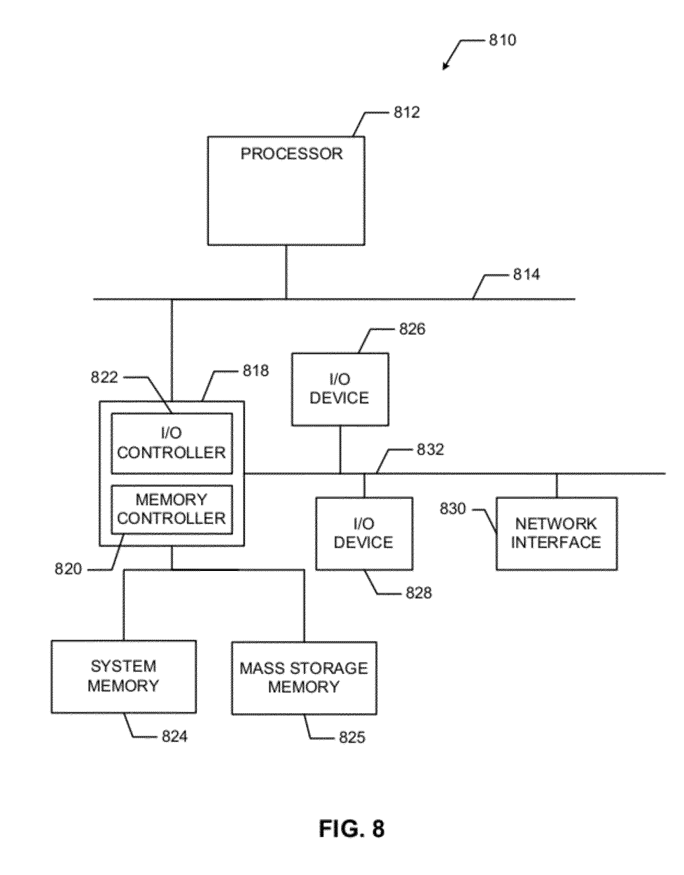

FIG. 8 is a block diagram of an example processor system 810 that can be used to implement systems and methods described herein. As shown in FIG. 8, the processor system 810 includes a processor 812 that is coupled to an interconnection bus 814. The processor 812 can be any suitable processor, processing unit, or microprocessor, for example. Although not shown in FIG. 8, the system 810 can be a multi-processor system and, thus, can include one or more additional processors that are identical or similar to the processor 812 and that are communicatively coupled to the interconnection bus 814.

The processor 812 of FIG. 8 is coupled to a chipset 818, which includes a memory controller 820 and an input/output (“I/O”) controller 822. As is well known, a chipset typically provides I/O and memory management functions as well as a plurality of general purpose and/or special purpose registers, timers, etc. that are accessible or used by one or more processors coupled to the chipset 818. The memory controller 820 performs functions that enable the processor 812 (or processors if there are multiple processors) to access a system memory 824 and a mass storage memory 825.

The system memory 824 can include any desired type of volatile and/or non-volatile memory such as, for example, static random access memory (SRAM), dynamic random access memory (DRAM), flash memory, read-only memory (ROM), etc. The mass storage memory 825 can include any desired type of mass storage device including hard disk drives, optical drives, tape storage devices, etc.

The I/O controller 822 performs functions that enable the processor 812 to communicate with peripheral input/output (“I/O”) devices 826 and 828 and a network interface 830 via an I/O bus 832. The I/O devices 826 and 828 can be any desired type of I/O device such as, for example, a keyboard, a video display or monitor, a mouse, etc. The network interface 830 can be, for example, an Ethernet device, an asynchronous transfer mode (“ATM”) device, an 802.11 device, a DSL modem, a cable modem, a cellular modem, etc. that enables the processor system 810 to communicate with another processor system.

While the memory controller 820 and the I/O controller 822 are depicted in FIG. 8 as separate blocks within the chipset 818, the functions performed by these blocks can be integrated within a single semiconductor circuit or may be implemented using two or more separate integrated circuits.

Thus, certain examples provide for improved reading and interpretation of diagnostic imaging studies via a reviewing workstation, such as a PACS workstation. Certain examples provide a technical effect of saving, resuming, and modifying a workflow and presentation state based on interaction between image review and a report.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

One or more of the components of the systems and/or steps of the methods described above can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples of the present invention can omit one or more of the method steps and/or perform the steps in a different order than the order listed. For example, some steps cannot be performed in certain examples of the present invention. As a further example, certain steps can be performed in a different temporal order, including simultaneously, than listed above.

Certain examples include computer-readable media for carrying or having computer-executable instructions or data structures stored thereon. Such computer-readable media can be any available media that can be accessed by a general purpose or special purpose computer or other machine with a processor. By way of example, such computer-readable media can comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory can include read only memory (ROM) and random access memory (RAM). The computer can also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for image review and reporting, said method comprising:
providing access to a report including one or more entries associated with image content;
facilitating user selection of an entry in the report;
displaying one or more images and image annotations associated with the entry in a viewer for the user;
configuring the viewer according to a presentation state and workflow associated with the entry; and
enabling user continuation of the workflow with respect to the presentation state and the one or more images and image annotations associated with the entry.

2. The method of claim 1, further comprising generating a report entry in response to user interaction with the one or more images and image annotations.

3. The method of claim 1, wherein the one or more image annotations comprise one or more of a measurement, a region of interest, a label, and a finding.

4. The method of claim 1, wherein the viewer comprises at least one of a radiology viewer and a dictation application.

5. The method of claim 1, wherein enabling further comprises facilitating at least one of user re-enactment and revision of the one or more image annotations.

6. The method of claim 1, wherein the report comprises a table including a plurality of entries associated with a plurality of different image content for selection by a user to view each of the image content according to a different presentation state and workflow point.

7. The method of claim 1, further comprising:
displaying an image for review;
facilitating user interaction with the image; and
automatically generating a report entry in response to the user interaction with the image.

8. An image analysis and reporting system, said system comprising:
a user interface to facilitate user review and interaction with image content and an associated report;
an image editor to provide access to image content for review and annotation via the user interface; and
a report manager to provide access to a report including one or more entries associated with image content via the user interface,
wherein the report manager is to work with the user interface to facilitate user selection of an entry in the report, and wherein the image editor is to work with the user interface to display one or more images and image annotations associated with the entry and to configure the user interface according to a presentation state and workflow associated with the entry, wherein the image editor is to enable user continuation of the workflow with respect to the presentation state and the one or more images and image annotations associated with the entry.

9. The system of claim 8, wherein the report manager is to generate a report entry in response to user interaction with the one or more images and image annotations via the user interface and the image editor.

10. The system of claim 8, wherein the one or more image annotations comprise one or more of a measurement, a region of interest, a label, and a finding.

11. The system of claim 8, wherein the user interface is incorporated with at least one of a radiology viewer and a dictation application.

12. The system of claim 8, wherein the user interface and the image editor are to enable at least one of user re-enactment and revision of the one or more image annotations.

13. The system of claim 8, wherein the report comprises a table including a plurality of entries associated with a plurality of different image content for selection by a user to view each of the image content according to a different presentation state and workflow point.

14. The system of claim 8, wherein the user interface and the image editor are to display an image for review and facilitate user interaction with the image, and wherein the report manager is to automatically generate a report entry in response to the user interaction with the image.

15. The system of claim 8, wherein the report entry comprises a lesion finding from an image.

16. A tangible computer readable medium having a set of instructions for execution on a processing device, the set of instructions implementing a method for image review and reporting, said method comprising:
providing access to a report including one or more entries associated with image content;
facilitating user selection of an entry in the report;
displaying one or more images and image annotations associated with the entry in a viewer for the user;
configuring the viewer according to a presentation state and workflow associated with the entry; and
enabling user continuation of the workflow with respect to the presentation state and the one or more images and image annotations associated with the entry.

17. The computer readable medium of claim 16, further comprising generating a report entry in response to user interaction with the one or more images and image annotations.

18. The computer readable medium of claim 16, wherein the one or more image annotations comprise one or more of a measurement, a region of interest, a label, and a finding.

19. The computer readable medium of claim 16, wherein enabling further comprises facilitating at least one of user re-enactment and revision of the one or more image annotations.

20. The computer readable medium of claim 16, wherein the report comprises a table including a plurality of entries associated with a plurality of different image content for selection by a user to view each of the image content according to a different presentation state and workflow point.

21. The computer readable medium of claim 16, wherein the method further comprises:
displaying an image for review;
facilitating user interaction with the image; and
automatically generating a report entry in response to the user interaction with the image.
